(19) United States
(12) Patent Application Publication
(10) Pub. No.: US 2020/0070124 A1
(43) Pub. Date: Mar. 5, 2020

(54) PHOTOCATALYTIC COATING, PROCESS FOR PRODUCING PHOTOCATALYTIC COATING, AND PROCESS FOR PRODUCING PHOTOCATALYTIC BODY

(71) Applicant: SHARP KABUSHIKI KAISHA, Sakai City (JP)

(72) Inventor: YOSHITAKA KAWASE, Sakai City (JP)

(21) Appl. No.: 16/549,477

(22) Filed: Aug. 23, 2019

(30) Foreign Application Priority Data
Aug. 31, 2018 (JP) 2018-163067

(51) Int. Cl. B01J 21/06; B01J 23/652; B01J 23/72; B01J 31/06; B01J 31/38; B01J 31/34; B01J 35/00; B01J 37/04; B01J 37/00; B01J 37/02; C02F 1/32; C02F 1/72

(52) U.S. Cl. CPC B01J 21/063; C02F 2101/308; B01J 23/72; B01J 31/06; B01J 31/38; B01J 31/34; B01J 35/004; B01J 37/04; B01J 37/0018; B01J 37/0219; B01J 37/0217; C02F 1/32; C02F 1/725; B01J 2231/005; B01J 2531/008; C02F 2305/10; B01J 23/6527

(57) ABSTRACT

This photocatalytic coating contains at least a photocatalytic particle, a binder and water. The binder includes a water-soluble hydrolysate of a silane coupling agent having an ethylene oxide structure. A content of the water-soluble hydrolysate of the silane coupling agent having the ethylene oxide structure is preferably 0.5% by weight or more and 20% by weight or less, based on a weight of a total solid content contained in the photocatalytic coating.

### BACKGROUND OF THE INVENTION

### Field of the Invention

The present invention relates to a photocatalytic coating, a process for producing the photocatalytic coating, and a process for producing a photocatalytic body.

### Description of the Background Art

A photocatalytic particle has photocatalytic activity. The photocatalytic activity is, for example, decomposition of harmful substances in the air, decomposition of malodor-causing substances, decomposition of pollutants dissolved or dispersed in water, decomposition of fungi, growth inhibition of fungi, suppression of dirt on exterior walls, or suppression of dirt on windows. In order to put the photocatalytic particle into practical use, the photocatalytic particle must be immobilized on a base material. For example, WO2011/059101 discloses an antifouling acrylic plate formed of an acrylic base material, a silica layer formed on the surface thereof, and a photocatalytic layer formed thereon. Between the surface of the acrylic base material and the silica layer, a binding layer formed of a silane coupling agent is provided.

However, the acrylic plate disclosed in WO2011/059101 is insufficient to firmly bind the base material and the photocatalytic particle to improve water resistance and durability because the base material and the silica layer are only bound by the silane coupling agent.

The present invention has been made in consideration of the above problem, and the object thereof is to provide a photocatalytic coating which is excellent in water resistance and durability, a process for producing the photocatalytic coating, and a process for producing a photocatalytic body while maintaining the photocatalytic activity.

### SUMMARY OF THE INVENTION

The photocatalytic coating of the present invention contains at least a photocatalytic particle, a binder and water. The binder includes a water-soluble hydrolysate of a silane coupling agent having an ethylene oxide structure.

The process for producing the photocatalytic coating of the present invention includes mixing the binder including the hydrolysate, the photocatalytic particle and water to give the photocatalytic coating.

The process for producing the photocatalytic body of the present invention is a process for producing a photocatalytic body including a base material and a photocatalytic layer provided on the base material. The process for producing the photocatalytic body of the present invention includes applying the photocatalytic coating on the base material and heating the photocatalytic coating to bind the photocatalytic particle and the base material via the binder including the hydrolysate.

The photocatalytic coating of the present invention, and the photocatalytic coating produced by the production process of the present invention are excellent in water resistance and durability while maintaining photocatalytic activity. In addition, the photocatalytic body produced by the production process of the present invention are excellent in water resistance and durability while maintaining the photocatalytic activity.

### DESCRIPTION OF THE PREFERRED EMBODIMENTS

Hereinafter, although embodiments of the present invention will be described in detail, the present invention is not limited at all to the following embodiments. The present invention may be implemented with appropriate modifications within the scope of the object of the present invention. Descriptions may be omitted as appropriate in places where descriptions overlap, but the subject matter of the invention is not limited.

Hereinafter, the names of compounds may be followed by “system” to comprehensively generically refer to the compounds and their derivatives.

### First Embodiment: Photocatalytic Coating

The first embodiment of the present invention relates to a photocatalytic coating (hereinafter, it may be described as “coating”). The coating of the first embodiment contains at least a photocatalytic particle, a binder and water. The coating preferably further contains a spacer particle. In addition, the coating may further contain an additive if desired. The coating of the first embodiment is a water-based coating containing water. The use of water as solvent of the coating may reduce an environmental load and improve a working environment.

### Binder

The Binder binds a base material to which the coating is applied and the photocatalytic particle. The binder includes a water-soluble hydrolysate of a silane coupling agent having an ethylene oxide structure. Hereinafter. “silane coupling agent having an ethylene oxide structure” may be described as “silane coupling agent X”. In addition, “water-soluble hydrolysate of a silane coupling agent having an ethylene oxide structure” may be described as “hydrolysate Y”.

The silane coupling agent X has at least a silicon atom, an alkoxy group bonded to the silicon atom, and a group having an ethylene oxide structure bonded to the silicon atom. The hydrolysate Y is a hydrolysate of the silane coupling agent X. Hydrolysis of the silane coupling agent X gives the hydrolysate Y. When the silane coupling agent X is hydrolyzed, the alkoxy group bonded to the silicon atom is hydrolyzed to form a hydroxy group bonded to the silicon atom. Then, the hydrolysate Y is given, which has at least the silicon atom, the hydroxy group bonded to the silicon atom (i.e. silanol group, Si—OH), and the group having the ethylene oxide structure bonded to the silicon atom.

The inclusion of the hydrolysate Y in the binder provides the first to the fourth advantages described below. First, the first advantage is described. When the coating is applied to the base material and heated, some of silanol groups of the hydrolysate Y and hydroxy groups on a surface of the base material are dehydrated and condensed to form a chemical bond between the hydrolysate Y and the base material. In addition, some of silanol groups of the hydrolysate Y and hydroxy groups on the surface of the photocatalytic particle are dehydrated and condensed to form a chemical bond between the hydrolysate Y and the photocatalytic particle. The occurrence of these dehydrations and condensations may cause the photocatalytic particle and the base material to bind firmly via the binder including the hydrolysate Y when the coating is applied to the base material and heated. The firmly binding may improve water resistance and durability of a photocatalytic layer formed using the coating.

Then, the second advantage is described. When the coating is applied to the base material and heated, the dehydration and condensation of some of silanol groups of the hydrolysate Y with one another causes the hydrolysates Y to bind to one another. In addition, a ring opening of the ethylene oxide structure of the hydrolysate Y and bonding to one another causes the hydrolysates Y to bond to one another. The bonding of the hydrolysates Y to one another in this way may further cause the photocatalytic particle and the base material to bind firmly via the binder including the hydrolysate Y when the coating is applied to the base material and heated. The firmly binding may improve the water resistance and the durability of the photocatalytic layer formed using the coating.

Then, the third advantage is described. Having the ethylene oxide structure increases the affinity of the hydrolysate Y for water. The high affinity for water makes the hydrolysate Y more compatible with the water-based coating containing water.

Then, the fourth advantage is described. In general, when the coating is applied to the base material and heated, the hydrolysis of the silane coupling agent occurs, followed by the dehydration and condensation occurs. In general, the hydrolysis of the silane coupling agent takes some time. However, the coating of the first embodiment contains the hydrolysate Y to which the silane coupling agent X is hydrolyzed. Therefore, when the coating is applied to the base material and heated, only the dehydration and condensation of the hydrolysate Y occurs, and the hydrolysis may be omitted. Therefore, the time for the hydrolysis may be omitted, and the time for producing a photocatalytic body described below in the third embodiment may be shortened.

The hydrolysate Y is water-soluble. The hydrolysate Y being water soluble allows the hydrolysate Y to stably exist in a coating containing water. The hydrolysate Y being water-soluble herein refers to that the hydrolysate Y dissolves in water when 5 parts by weight of the hydrolysate Y is added to 95 parts by weight of water under the environment of 25° C. Whether the hydrolysate Y dissolved in water may be visually confirmed.

The ethylene oxide structure possessed by the silane coupling agent X is represented by the following chemical formula (2). A suitable example of the silane coupling agent X having the ethylene oxide structure includes a silane coupling agent X having an epoxy group. The epoxy group is represented by the following chemical formula (2-1). In chemical formula (2-1), * represents a bond. In addition, another suitable example of the silane coupling agent X having the ethylene oxide structure includes a silane coupling agent X having a condensed ring group in which ethylene oxide and a cycloalkane having 3 or more carbon atoms are condensed. Such a condensed ring group is represented by chemical formula (2-2). In chemical formula (2-2), p and q each independently represents an integer of 0 or more, and * represents a bond. In chemical formula (2-2), p preferably represents an integer of 0 to 5, and more preferably 1. q preferably represents an integer of 0 to 5, and more preferably 2.

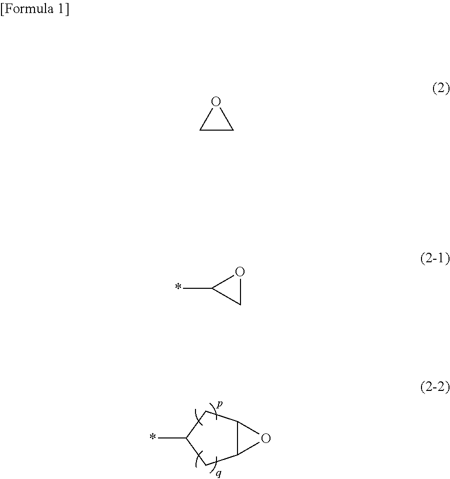

The silane coupling agent X is preferably the silane coupling agent represented by general formula (1X). Hereinafter, “silane coupling agent represented by general formula (1X)” may be described as “silane coupling agent (1X)”.

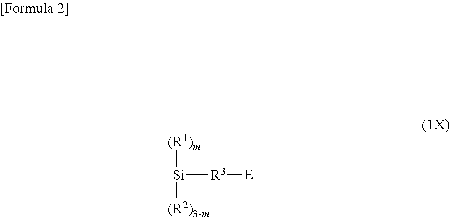

In general formula (1X), R¹ represents an alkoxy group. R² represents an alkyl group. R³ represents an alkylene group. m represents an integer of 1 to 3. E represents the group represented by general formula (E1) or (E2).

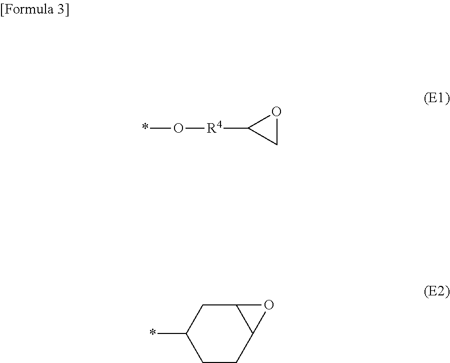

In general formula (E1), R⁴ represents an alkylene group, * represents a bond bonded to R³. In general formula (E2), * represents a bond bonded to R³. A silane coupling agent (1X) in which E in general formula (1X) represents the group represented by general formula (E1) is a suitable example of the silane coupling agent X having the above epoxy group. A silane coupling agent (1X) in which E in general formula (1X) represents a group represented by general formula (E2) is a suitable example of the silane coupling agent X having the condensed ring group in which the above ethylene oxide and the cycloalkane having 3 or more carbon atoms are condensed.

The alkoxy group represented by R¹ in general formula (1X) is linear or branched and unsubstituted. The alkoxy group represented by R¹ in general formula (1X) is preferably an alkoxy group having 1 to 6 carbon atoms, more preferably an alkoxy group having 1 to 3 carbon atoms, still more preferably a methoxy group or an ethoxy group.

The alkyl group represented by R² in general formula (1X) is linear or branched and unsubstituted. The alkyl group represented by R² in general formula (1X) is preferably an alkyl group having 1 to 6 carbon atoms, more preferably an alkyl group having 1 to 3 carbon atoms, further preferably a methyl group or an ethyl group.

The alkylene group represented by R³ in general formula (1X) is linear or branched and unsubstituted. The alkylene group represented by R³ in general formula (1X) is preferably an alkylene group having 1 to 6 carbon atoms, more preferably an alkylene group having 1 to 3 carbon atoms, further preferably a methylene group (—CH₂—), an ethylene group (—CH₂—CH₂—), or a propylene group (—CH₂—CH₂—CH₂—), particularly preferably a propylene group (—CH₂—CH₂—CH₂—).

When m in general formula (1X) is 2 or 3, two or three R¹ may be the same or different from one another. When m in general formula (1X) is 1, two R² may be the same or different from one another. m in general formula (1X) preferably represents 2 or 3, and more preferably 3.

The alkylene group represented by R⁴ in general formula (E1) is linear or branched and unsubstituted. The alkylene group represented by R⁴ in general formula (E1) is preferably an alkylene group having 1 to 6 carbon atoms, more preferably an alkylene group having 1 to 3 carbon atoms, further preferably a methylene group (—CH₂—), an ethylene group (—CH₂—CH₂—), or a propylene group (—CH₂—CH₂—CH₂—), particularly preferably a methylene group (—CH₂—).

Examples of the silane coupling agent X include γ-glycidoxypropyltrimethoxysilane (i.e. 3-glycidoxypropyltrimethoxysilane), γ-glycidoxypropyltriethoxysilane, γ-glycidoxypropyldimethoxymethylsilane, γ-glycidoxypropyldiethoxymethylsilane, γ-glycidoxypropylethoxydimethylsilane, β-(3,4-epoxycyclohexyl) ethyltrimethoxysilane, β-(3,4-epoxycyclohexyl) ethyltriethoxysilane, and 5,6-epoxyhexyltriethoxysilane. A suitable example of the silane coupling agent X includes 3-glycidoxypropyltrimethoxysilane.

The hydrolysate Y is preferably the hydrolysate represented by general formula (1Y). Hereinafter, “hydrolysate represented by general formula (1Y)” may be described as “hydrolysate(1Y)”. The hydrolysate (1Y) is given by hydrolyzing the silane coupling agent (1X). R², R³, m, and E in general formula(1Y) each is synonymous with R², R³, m, and E in general formula(1X).

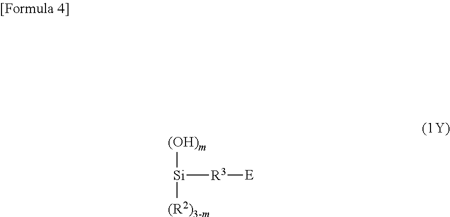

Examples of the hydrolysate Y include γ-glycidoxypropyltrihydroxysilane (i.e. 3-glycidoxypropyltrihydroxysilane), γ-glycidoxypropyltrihydroxysilane, γ-glycidoxypropyldihydroxymethylsilane, γ-glycidoxypropyldihydroxymethylsilane, γ-glycidoxypropylhydroxydimethylsilane, β-(3,4-epoxycyclohexyl) ethyltrihydroxysilane, β-(3,4-epoxycyclohexyl) ethyltrihydroxysilane, and 5,6-epoxyhexyltrihydroxysilane. A suitable example of the hydrolysate Y includes 3-glycidoxypropyltrihydroxysilane.

A commercially available product may be used as the silane coupling agent X. Examples of the commercially available silane coupling agent X include KBM-403 (3-glycidoxypropyltrimethoxysilane), KBE-403 (3-glycidoxypropyltriethoxysilane), and KBM-303 (2-(3,4-epoxycyclohexyl) ethyltrimethoxysilane) sold by Shin-Etsu Chemical Co., Ltd. Other examples of the commercially available silane coupling agent X include Silquest A-187 (3-glycidoxypropyltriunethoxysilane), Silquest A-1871 (3-glycidoxypropyltriethoxysilane), and Silquest A-186 (2-(3,4-epoxycyclohexyl) ethyltrimethoxysilane) sold by Momentive Performance Materials Inc. Other examples of the commercially available silane coupling agent X include Dynasylan GLYMO (3-glycidoxypropyltrimethoxysilane), and Dynasylan GLYEO (3-glycidoxypropyltriethoxysilane) sold by Evonik Degussa Japan Co., Ltd. Other examples of the commercially available silane coupling agent X include 3-glycidyloxypropyltrimethoxysilane, 3-glycidyloxypropyl (dimethoxy) methylsilane, triethoxy (3-glycidyloxypropyl) silane, and diethoxy (3-glycidyloxypropyl) methylsilane sold by Tokyo Chemical Industry Co., Ltd. After hydrolyzing these silane coupling agents X, the resulting hydrolysates Y may be added to the coating. In addition, a commercially available product may be used as the hydrolysate Y. An example of the commercially available hydrolysate Y includes Dynasylan SIVO110 sold by Evonik Degussa Japan Co., Ltd. Since the hydrolysate Y is already hydrolyzed, it may be added to the coating without being hydrolyzed.

The coating may contain only one type of the hydrolysate Y, or may contain two or more types of the hydrolysate Y. In addition, the coating may contain only the hydrolysate Y, or may further contain a hydrolysate of a silane coupling agent other than the hydrolysate Y.

In order to improve the water resistance and the durability while maintaining photocatalytic activity, the content of the hydrolysate Y is preferably 0.5% by weight or more and 25% by weight or less, based on the weight of the total solid content contained in the coating. The total solid content contained in the coating is a component obtained by removing solvent (e.g. water) from the components contained in the coating.

In order to particularly improve the photocatalytic activity while improving the water resistance and the durability, the content of the hydrolysate Y is more preferably 0.5% by weight or more and 20% by weight or less, further preferably 0.5% by weight or more and 10% by weight or less, even more preferably 0.5% by weight or more and 5% by weight or less, particularly preferably 2% by weight or more and 5% by weight or less, based on the weight of the total solid content contained in the coating. The hydrolysate Y is dehydrated and condensed with the photocatalytic particle, and the hydrolysate Y is dehydrated and condensed with the base material, whereby the photocatalytic particle and the base material are firmly bound via the binder including the hydrolysate Y. Therefore, even when the content of the hydrolysate Y, which is a binder, is low, the photocatalytic particle and the base material are firmly bound via the binder. Therefore, the addition amount of the hydrolysate Y, which is a binder, may be reduced. This may suppress loss of the photocatalytic activity of the photocatalytic layer by the binder and may suppress burying of the photocatalytic particle in the binder. Consequently, the photocatalytic activity may be particularly improved while improving the water resistance and the durability.

### Photocatalytic Particle

The photocatalytic particle has the photocatalytic activity. In detail, light having energy equal to or greater than an energy gap between a valence band and a conduction band is irradiated to the photocatalytic particles. The irradiation of the light excites the electrons in the valence band of the photocatalytic particle to the conduction band, and holes are generated in the valence band. The electrons and holes move inside the photocatalytic particle. The reduction of oxygen by the electron generates a superoxide anion. Oxidation of water by the hole generates a hydroxy radical. The generated hydroxy radical generates active oxygen species. The generated active oxygen species achieves, for example, decomposition of harmful substances, antibacterial and antifouling.

Examples of the photocatalytic particle preferably include titanium oxide, tungsten oxide, strontium titanate (SrTiO₃), niobium oxide (Nb₂O₅), tantalum oxide (Ta₂O₅), zirconium oxide (ZrO₂), bismuth oxide (Bi₂O₃), or Iron oxide (Fe₂O₃). The coating may contain only one type of the photocatalytic particle, or may contain two or more types of the photocatalytic particles.

In order to obtain a coating excellent in photocatalytic activity, the photocatalytic particle preferably includes titanium oxide or tungsten oxide.

Titanium oxide is TiO₂ (titanium dioxide). Titanium oxide is not particularly limited, and a commercially available product may be used appropriately as titanium oxide. Examples of the crystal structure of titanium oxide include anatase type, rutile type, and brookite type, and mixed crystal thereof. In order to improve the photocatalytic activity, the anatase type is preferred as a crystal structure of titanium oxide.

Tungsten oxide is not particularly limited, and a commercially available product may be used appropriately as tungsten oxide. Examples of tungsten oxide include WO₃ (tungsten trioxide), WO₂, WO, W₂O₃, W₄O₅, W₄O₁₁, W₂₅O₇₃, W₂₀O₅₈, and W₂₄O₆₈, and mixtures thereof. In order to improve the photocatalytic activity, the WO₃ is preferred as tungsten oxide. Some of tungsten oxide may be reduced to a V value. However, tungsten oxide is preferably used after being oxidized to a VI value. An example of the process for oxidizing to the VI value includes a process for calcining tungsten oxide at high temperature. The crystal structure of tungsten oxide is not particularly limited.

An average particle size of the photocatalytic particle is preferably 5 nm or more and 200 nm or less. When the average particle size of the photocatalytic particle is 5 nm or more, the photocatalytic particle is less likely to aggregate and redispersion of the photocatalytic particle is facilitated. When the average particle size of the photocatalytic particle is 200 nm or less, the photocatalytic particle and other components tend to be uniformly mixed, and release of the photocatalytic particle from the photocatalytic layer formed of the coating may be suppressed. The average particle size of the photocatalytic particle is a value calculated on the assumption that the primary particle of the photocatalytic particle is spherical, based on the specific surface area (unit: m²/g) of the photocatalytic particle measured by the BET method. The method for measuring the average particle size of the photocatalytic particle is described below in the Examples.

A cocatalyst particle may be provided on the surface of the photocatalytic particle. The cocatalyst particle is preferably a metal particle, more preferably a transition metal particle, further preferably a platinum group metal particle. Examples of the platinum group metal particle include particles of Pt, Pd, Rh, Ru, Os, and Ir. The provision of the cocatalyst particle on the surface of the photocatalytic particle may reduce the energy gap between the valence band and the conduction band of the photocatalytic particle to improve a light response in the visible light range.

The content of the photocatalytic particle is preferably 75% by weight or more and 99% by weight or less, more preferably 80% by weight or more and 99% by weight or less, further preferably 90% by weight or more and 99% by weight or less, even more preferably 95% by weight or more and 99% by weight or less, particularly preferably 98% by weight or more and 99% by weight or less, based on the weight of the total solid content contained in the coating. The hydrolysate Y is dehydrated and condensed with the photocatalytic particle, and the hydrolysate Y is dehydrated and condensed with the base material, whereby the photocatalytic particle and the base material are firmly bound via the binder including the hydrolysate Y. Therefore, when the content of the photocatalytic particle is high, that is, even when the content of the binder is low, the photocatalytic particle and the base material are firmly bound via the binder. Therefore, the addition amount of the hydrolysate Y, which is a binder, may be reduced. This may suppress loss of the photocatalytic activity of the photocatalytic layer by the binder and may suppress burying of the photocatalytic particle in the binder. Consequently, the photocatalytic activity may be particularly improved while improving the water resistance and the durability.

### Spacer Particle

The coating preferably further contains the spacer particle in addition to the photocatalytic particle, the binder and water. The spacer particle has an average particle size larger than that of the photocatalytic particle. When the photocatalytic particle contains metal or metal oxide, the spacer particle contains metal or metal oxide different from the metal or metal oxide of the photocatalytic particle. In the case where the spacer particle is contained in the coating, when the photocatalytic layer formed of the coating comes in contact with the photocatalytic layer or a member other than the photocatalytic layer by shaking or impact, the spacer particle contained in the photocatalytic layer absorbs friction and impact. Therefore, the photocatalytic layer formed of the coating becomes strong against friction and impact, and the photocatalytic activity of the photocatalytic particle may be exhibited for a long time. In addition, metals and metal oxides are less likely to be degraded by the photocatalytic particles as compared to resins that are organic polymers. Therefore, the spacer particle containing metal and metal oxide is excellent in durability.

The metal contained in the spacer particle is not particularly limited, but is preferably a metal of Group 10, Group 11, or Group 12 of the periodic table, and more preferably one or more metals selected from the group consisting of silver, zinc and copper. The metal oxide contained in the spacer particle is not particularly limited, but is preferably an oxide of a metal of Group 10, Group 11, or Group 12 of the periodic table, and more preferably oxides of one or more metals selected from the group consisting of silver, zinc and copper. Such a metal and a metal oxide have antimicrobial performance, so that both the photocatalytic activity of the photocatalytic particle and the antimicrobial performance of the spacer particle may be imparted to the coating. In order to improve the antimicrobial performance, the spacer particle preferably contains one or more metals or oxides thereof selected from the group consisting of silver, zinc and copper, and more preferably cuprous oxide.

The average particle size of the spacer particle is preferably 200 nm or more and 1,000 nm or less. The average particle size of the spacer particle is a value calculated on the assumption that the primary particle of the spacer particle is spherical, based on the specific surface area (unit: m²/g) of the spacer particle measured by the BET method. The method for measuring the average particle size of the spacer particle is described below in the Examples.

When the coating contains the spacer particle, the content of the spacer particle is preferably 0.1% by weight or more and 5.0% by weight or less, more preferably 0.1% by weight or more and 2.0% by weight or less, further preferably 0.1% by weight or more and 1.0% by weight or less, based on the weight of the total solid content of the coating.

### Additive

An example of the additive which the coating may contain includes an organic compound having an anti-algal effect. Examples of the organic compound having the anti-algal effect include organic nitrogen sulfur compounds, pyrithione compounds, organic iodine compounds, triazine compounds, isothiazoline compounds, imidazole compounds, pyridine compounds, nitrile compounds, thiocarbamate compounds, thiazole compounds and disulfide compounds.

### Second Embodiment: Process for Producing Coating

The second embodiment of the present invention relates to a process for producing a coating. The coating produced by the production process of the second embodiment is the coating of the first embodiment. The coating produced by the production process of the second embodiment is excellent in water resistance and durability while maintaining photocatalytic activity for the same reason as described in the first embodiment. The process for producing the coating of the second embodiment includes, for example, a coating preparation step. In the process for producing the coating of the second embodiment, a hydrolysis step may be implemented before the coating preparation step. However, when using a commercially available hydrolysate Y, the hydrolysis step may be omitted.

### Hydrolysis Step

In the hydrolysis step, a silane coupling agent X is hydrolyzed to give a hydrolysate Y. An example of a process for hydrolyzing the silane coupling agent X includes a process for adding the silane coupling agent X to water. Since the silane coupling agent X has an ethylene oxide structure with high affinity for water, hydrolysis of the silane coupling agent X may be carried out without adding an acid to water. However, in order to accelerate the hydrolysis, the acid may be added to water to which the silane coupling agent X is added to hydrolyze the silane coupling agent X under acid conditions. Since it is difficult to be dehydrated and condensed, the hydrolysis of the silane coupling agent X is preferably carried out without heating.

### Coating Preparation Step

In the coating preparation step, a binder including the hydrolysate Y, a photocatalytic particle and water are mixed to give the coating of the first embodiment. In order to improve dispersibility, the hydrolysate Y and the photocatalytic particle are preferably mixed after the hydrolysate Y is given. In the coating preparation step, the hydrolysis treatment is preferably not carried out. The photocatalytic particle may be added in the form of a photocatalytic liquid containing the photocatalytic particle and a solvent or a dispersion medium. In addition, the binder may be added in the form of a binder liquid containing the binder and a solvent or a dispersion medium. Examples of the solvent and the dispersion medium contained in the photocatalytic liquid include polar solvents, more particularly water, methanol, ethanol and propanol. Examples of the solvent and the dispersion medium contained in the binder liquid include polar solvents, more particularly water, methanol, ethanol and propanol. In the hydrolysis step, when the silane coupling agent X is added to water to give an aqueous solution of the hydrolysate Y, the aqueous solution of the hydrolysate Y may be used as a binder liquid. In the coating preparation step, an additive may be further added and mixed.

### Third Embodiment: Process for Producing Photocatalytic Body

The third embodiment of the present invention relates to a process for producing a photocatalytic body. In the process for producing the photocatalytic body of the third embodiment, the coating of the first embodiment is used. Since the coating of the first embodiment is used, the photocatalytic body produced by the production process of the third embodiment is excellent in water resistance and durability while maintaining photocatalytic activity for the same reason as described in the first embodiment. The photocatalytic body produced by the production process of the third embodiment includes a base material and a photocatalytic layer. The photocatalytic layer is provided on the base material. The photocatalytic layer may be disposed directly on the base material. Alternatively, the photocatalytic layer may be disposed on the base material via a primer layer. The primer layer is formed of a primer coating. The process for producing the photocatalytic body of the third embodiment includes, for example, a photocatalytic layer formation step.

### Photocatalytic Layer Formation Step

In the photocatalytic layer formation step, the coating of the first embodiment is applied to the base material and heated. The heating causes a photocatalytic particle and the base material to bind via a binder including a hydrolysate Y. The heating removes at least some of water contained in the coating. In this way the photocatalytic layer containing the photocatalytic particle, the binder including the hydrolysate Y, and an optional spacer particle is formed on the base material. Since the coating of the first embodiment contains the binder including the hydrolysate Y, the photocatalytic layer may be formed in the photocatalytic layer formation step without any hydrolysis treatment.

The coating of the first embodiment contains the binder including the hydrolysate Y. Heating the coating dehydrates and condenses the hydrolysate Y and the photocatalytic particle, and dehydrates and condenses the hydrolysate Y and the base material. A chemical bond formed by these dehydrations and condensations causes the photocatalytic particle and the base material to bind firmly via the binder. Firmly binding may improve the water resistance and the durability of the photocatalytic body including the photocatalytic layer formed of the coating of the first embodiment. Due to the excellent water resistance and durability, the photocatalytic body produced by the production process of the third embodiment may suitably exhibit the photocatalytic activity in any environment such as indoor, outdoor, in the air and in water.

Examples of the material of the base material (in particular, support) include glass, plastic, metal, ceramics, wood, stone, cement, concrete, fiber, fabric, paper, and leather, and combinations thereof. The base material may be a laminate including multiple layers of different materials. The coating of the first embodiment contains the hydrolysate Y as a binder. Therefore, even if the base material is such a material, the hydrolysate Y and the base material are dehydrated and condensed, and the hydrolysate Y and the photocatalytic particle are dehydrated and condensed. The chemical bond formed by these dehydrations and condensations causes the photocatalytic particle and the base material to bind firmly via the binder.

A process for applying the coating on the base material is not particularly limited. Examples of the process for applying the coating on the base material include a spin coat process, a dip process, a spray process, a roll coat process, a gravure process, a wire bar process, an air knife process and an ink jet process. The coating may be applied to at least a portion of the base material. The thickness of the photocatalytic layer formed is not particularly limited. Even with the thickness of the photocatalytic layer obtained by any application process, the effect of the coating of the first embodiment may be given.

A process for heating the coating applied to the base material is not particularly limited. Examples of the process for heating the coating applied to the base material include forced drying using a dryer and calcination. The temperature of the process for heating the coating applied to the base material is preferably 100° C. or more and 1000° C. or less, more preferably 100° C. or more and 300° C. or less.

A surface of the base material is preferably modified to be hydrophilic before the coating is applied to the base material. The modification to be hydrophilic of the surface of the base material may improve wettability of the coating to the base material, and form the photocatalytic layer with a more uniform film thickness.

Examples of the process for modifying the surface of the base material to be hydrophilic include chemical treatment, mechanical treatment, corona treatment, flame treatment, ultraviolet radiation treatment, high frequency treatment, glow discharge treatment, plasma treatment, laser treatment, mixed acid treatment and ozone oxidation treatment. Another example of the process for modifying the surface of the base material to be hydrophilic includes a process for applying the primer coating on the base material to form the primer layer on the base material. Plasma treatment, ultraviolet radiation treatment, corona treatment, or glow discharge treatment is preferable among these processes, and ultraviolet radiation treatment is more preferable.

An example of ultraviolet radiation will be described. The surface of the base material is irradiated with ultraviolet light using an apparatus that irradiates ultraviolet light. In this way, the surface of the base material is irradiated with ultraviolet light to modify the surface of the base material to be hydrophobic before the coating is applied to the substrate. Since the surface of the base material is easily modified to be hydrophobic, the wavelength of the ultraviolet light is preferably 150 nm or more and 350 nm or less, and more preferably 200 nm or more and 300 nm or less. The apparatus that irradiates the ultraviolet light is not particularly limited, and a known apparatus may be used as appropriate. Examples of the ultraviolet light source include low-pressure mercury lamps and excimer lamps. The wavelength (λ) of the ultraviolet light irradiated from the low-pressure mercury lamp is, for example, 254 nm and 185 nm. The wavelength (λ) of the ultraviolet light irradiated from the excimer lamp is, for example, at least one of wavelength 308 nm (XeCl* lamp), 227 nm (KrCl* lamp), 172 nm (Xe₂* lamp), 126 nm (Ar₂* lamp) and 146 nm (Kr₂* lamp). The irradiation time of the ultraviolet light varies depending on the irradiance and irradiation conditions and the like, but is, for example, 1 minute or more and 1 hour or less. The first embodiment to the third embodiment has been described above.

### Examples

Hereinafter, the present invention will be more particularly described by showing the Examples. However, the present invention is not limited to the Examples. “Average particle size” described below was measured by the following method. In detail, a specific surface area Sm of particles to be measured (e.g. photocatalytic particles or spacer particles) per unit mass was measured using a specific surface area and pore distribution measuring apparatus (“NOVA e series 4200e” manufactured by Quantachrome Instruments). Then, the average particle size d of the measured particles was calculated from the measured specific surface area Sm of the measured particles according to formula (1). Average particle size d=6/(specific surface area Sm of measured particles×density ρ of measured particles)—(1)

Table 1 shows the compositions of the coatings (A-1) to (A-12) and (B-1) to (B-4) according to Examples and Comparative Examples.

TABLE 1

| | | | | | | Content |
|---|---|---|---|---|---|---|
| | | Photocatalytic | | | Spacer | Photocatalyst/ |
| | Coating | Particle | Solvent | Binder | Particle | Binder/Spacer |
| Example 1 | A-1 | TiO₂ | Water | 3-Gly | — | 99/1/0 |
| Example 2 | A-2 | TiO₂ | Water | 3-Gly | — | 95/5/0 |
| Example 3 | A-3 | TiO₂ | Water | 3-Gly | — | 90/10/0 |
| Example 4 | A-4 | TiO₂ | Water | 3-Gly | — | 80/20/0 |
| Example 5 | A-5 | Pt—WO₃ | Water | 3-Gly | — | 99/1/0 |
| Example 6 | A-6 | Pt—WO₃ | Water | 3-Gly | — | 95/5/0 |
| Example 7 | A-7 | Pt—WO₃ | Water | 3-Gly | — | 90/10/0 |
| Example 8 | A-8 | Pt—WO₃ | Water | 3-Gly | — | 80/20/0 |
| Example 9 | A-9 | TiO₂ | Water | 3-Gly | Cuprous Oxide | 98/1/1 |
| Example 10 | A-10 | Pt—WO₃ | Water | 3-Gly | Cuprous Oxide | 98/1/1 |
| Example 11 | A-11 | TiO₂ | Water | 3-Gly | — | 75/25/0 |
| Example 12 | A-12 | Pt—WO₃ | Water | 3-Gly | — | 75/25/0 |
| Comparative | B-1 | TiO₂ | Water | — | — | 100/0/0 |
| Example 1 | | | | | | |
| Comparative | B-2 | Pt—WO₃ | Water | — | — | 100/0/0 |
| Example 2 | | | | | | |
| Comparative | B-3 | TiO₂ | Water | vinyl | — | 99/1/0 |
| Example 3 | | | | | | |
| Comparative | B-4 | TiO₂ | Water | vinyl | — | 90/10/0 |
| Example 4 | | | | | | |

“TiO₂” in Table 1 represents a titanium oxide particle. “TKP-101 (anatase type titanium oxide)” manufactured by Tayca Corporation, was used as a titanium oxide particle that is a photocatalytic particle. The average particle size of TKP-101 titanium oxide was 6 nm.

“Pt—WO₃” in Table 1 represents a platinum-supported tungsten oxide particle. The platinum-supported tungsten oxide particle, which is a photocatalytic particle, was made by the process described below. In detail, 200 g of tungsten oxide (manufactured by Kishida Chemical Co., Ltd.) and 100 mL of pure water were mixed and then dispersed while being irradiated with ultrasonic waves to give dispersion A of the tungsten oxide particles. Hexachloroplatinum (VI) hexahydrate (manufactured by Kishida Chemical Co., Ltd., purity 98.5%) was dissolved in the dispersion A to give dispersion B of the tungsten oxide particles. An addition amount of hexachloroplatinum (VI) hexahydrate was an amount such that a proportion of the weight of platinum alone to the weight of the tungsten oxide particle was 0.05% by weigh. The dispersion B was heated at 100° C. to evaporate the water, and then calcined at 500° C. to given a platinum-supported tungsten oxide particle. The average particle size of the resulting platinum-supported tungsten oxide particle was 175 nm.

“3-Gly” in Table 1 represents a hydrolysate of 3-glycidoxypropyltrimethoxysilane. 3-glycidoxypropyltrimethoxysilane was a silane coupling agent having an ethylene oxide structure. The hydrolysate of 3-glycidoxypropyltrimethoxysilane, which is a binder, was prepared by hydrolyzing 3-glycidoxypropyltrimethoxysilane (manufactured by Tokyo Chemical Industry Co., Ltd.) by the process described later.

When 5 parts by weight of the hydrolysate of 3-glycidoxypropyltrimethoxysilane (manufactured by Tokyo Chemical Industry Co., Ltd.) was added to 95 parts by weight of water under an environment of 25° C., it was visually confirmed that the hydrolysate of 3-glycidoxypropyltrimethoxysilane was dissolved in water.

“vinyl” in Table 1 represents a hydrolysate of vinyltrimethoxysilane. The vinyltrimethoxysilane was not the silane coupling agent having the ethylene oxide structure. The hydrolysate of vinyltrimethoxysilane, which is a binder, was prepared by hydrolyzing vinyltrimethoxysilane (manufactured by Tokyo Chemical Industry Co., Ltd.) by the process described later.

“cuprous oxide” in Table 1 represents cuprous oxide which is a spacer particle. As cuprous oxide, “FRC-05B” manufactured by Furukawa Chemicals Co., Ltd. (average particle size: 430 nm) was used.

As “water” in Table 1, pure water was used. “-” in Table 1 represents that the coating does not contain the corresponding materials. “Content photocatalytic/binder/spacer” in Table 1 represents “photocatalytic content/binder content/spacer content”. The content of the photocatalytic particle represents the content (unit: % by weight) of the photocatalytic particle based on the weight of the total solid content of the coating. The content of the binder represents the content (unit: % by weight) of the binder based on the weight of the total solid content of the coating. The content of the spacer particle represents the content (unit: % by weight) of the spacer particle based on the weight of the total solid content of the coating. The weight of the total solid content of the coating was calculated by formula “weight of total solid content=addition amount of the photocatalytic particles+addition amount of the binder+addition amount of the spacer particles”.

Hereinafter, making processes, evaluation methods, and evaluation results of the coatings (A-1) to (A-12) and (B-1) to (B-4) shown in Table 1 will be described.

### Processes For Making Coatings

First, an aqueous dispersion of platinum-supported tungsten oxide particles used for making the coatings was prepared.

### Preparation of an Aqueous Dispersion of Platinum-supported Tungsten Oxide Particles

The platinum-supported tungsten oxide particles prepared above and pure water was mixed such that the solid content concentration of the aqueous dispersion of the platinum-supported tungsten oxide particles was 20% by weight. The mixture was dispersed while being irradiated with ultrasonic waves to make 1000 g of the aqueous dispersion of the platinum-supported tungsten oxide particles.

Then, each coating was prepared by the processes described below.

### Coating (A-1) Making

Titanium oxide and pure water were mixed to make 100 g of an aqueous dispersion of the titanium oxide. The content of the titanium oxide based on the weight of the resulting aqueous dispersion was 20% by weight. 3-glycidoxypropyltrimethoxysilane was mixed with pure water and hydrolyzed to make 10.1 g of an aqueous solution of 3-glycidoxypropyltrimethoxysilane hydrolysate. The content of the 3-glycidoxypropyltrimethoxysilane hydrolysate based on the weight of the resulting aqueous solution was 2% by weight. The above two liquids (aqueous dispersion and aqueous solution) were stirred using a magnetic stirrer and a stirrer to give a mixed liquid. To the mixed liquid was added 92.1 g of pure water to give 202.1 g of the coating (A-1) having a solid content concentration of 10% by weight. The content of the binder of the coating (A-1) was 1% by weight based on the weight of the total solid content contained in the coating (A-1).

### Coating (A-2) Making

Titanium oxide and pure water were mixed to make 100 g of an aqueous dispersion of the titanium oxide. The content of the titanium oxide based on the weight of the resulting aqueous dispersion was 20% by weight. 3-glycidoxypropyltrimethoxysilane was mixed with pure water and hydrolyzed to make 21.1 g of an aqueous solution of 3-glycidoxypropyltrimethoxysilane hydrolysate. The content of the 3-glycidoxypropyltrimethoxysilane hydrolysate based on the weight of the resulting aqueous solution was 5% by weight. The above two liquids (aqueous dispersion and aqueous solution) were stirred using a magnetic stirrer and a stirrer to give a mixed liquid. To the mixed liquid was added 89.0 g of pure water to give 210.1 g of the coating (A-2) having a solid content concentration of 10% by weight. The content of the binder of the coating (A-2) was 5% by weight based on the weight of the total solid content contained in the coating (A-2).

### Coating (A-3) Making

Titanium oxide and pure water were mixed to make 100 g of an aqueous dispersion of the titanium oxide. The content of the titanium oxide based on the weight of the resulting aqueous dispersion was 20% by weight. 3-glycidoxypropyltrimethoxysilane was mixed with pure water and hydrolyzed to make 44.4 g of an aqueous solution of 3-glycidoxypropyltrimethoxysilane hydrolysate. The content of the 3-glycidoxypropyltrimethoxysilane hydrolysate based on the weight of the resulting aqueous solution was 5% by weight. The above two liquids (aqueous dispersion and aqueous solution) were stirred using a magnetic stirrer and a stirrer to give a mixed liquid. To the mixed liquid was added 78.8 g of pure water to give the coating (A-3) having a solid content concentration of 10% by weight. The content of the binder of the coating (A-3) was 10% by weight based on the weight of the total solid content contained in the coating (A-3).

### Coating (A-4) Making

Titanium oxide and pure water were mixed to make 100 g of an aqueous dispersion of the titanium oxide. The content of the titanium oxide based on the weight of the resulting aqueous dispersion was 20% by weight. 3-glycidoxypropyltrimethoxysilane was mixed with pure water and hydrolyzed to make 100 g of an aqueous solution of 3-glycidoxypropyltrimethoxysilane hydrolysate. The content of the 3-glycidoxypropyltrimethoxysilane hydrolysate based on the weight of the resulting aqueous solution was 5% by weight. The above two liquids (aqueous dispersion and aqueous solution) were stirred using a magnetic stirrer and a stirrer to give a mixed liquid. To the mixed liquid was added 50.0 g of pure water to give 250.0 g of the coating (A-4) having a solid content concentration of 10% by weight. The content of the binder of the coating (A-4) was 20% by weight based on the weight of the total solid content contained in the coating (A-4).

### Coating (A-5) Making

3-glycidoxypropyltrimethoxysilane was mixed with pure water and hydrolyzed to make 10.1 g of an aqueous solution of 3-glycidoxypropyltrimethoxysilane hydrolysate. The content of the 3-glycidoxypropyltrimethoxysilane hydrolysate based on the weight of the resulting aqueous solution was 2% by weight. The aqueous solution of the 3-glycidoxypropyltrimethoxysilane hydrolysate and 100 g of the aqueous dispersion of platinum-supported tungsten oxide particles prepared above (platinum-supported tungsten oxide particle content: 20% by weight) were stirred using a magnetic stirrer and a stirrer to give a mixed liquid. To the mixed liquid was added 92.1 g of pure water to give the coating (A-5) having a solid content concentration of 10% by weight. The content of the binder of the coating (A-5) was 1% by weight based on the weight of the total solid content contained in the coating (A-5).

### Coating (A-6) Making

3-glycidoxypropyltrimethoxysilane was mixed with pure water and hydrolyzed to make 21.1 g of an aqueous solution of 3-glycidoxypropyltrimethoxysilane hydrolysate. The content of the 3-glycidoxypropyltrimethoxysilane hydrolysate based on the weight of the resulting aqueous solution was 5% by weight. The aqueous solution of the 3-glycidoxypropyltrimethoxysilane hydrolysate and 100 g of the aqueous dispersion of platinum-supported tungsten oxide particles prepared above (platinum-supported tungsten oxide particle content: 20% by weight) were stirred using a magnetic stirrer and a stirrer to give a mixed liquid. To the mixed liquid was added 89.0 g of pure water to give 210.1 g of the coating (A-6) having a solid content concentration of 10% by weight. The content of the binder of the coating (A-6) was 5% by weight based on the weight of the total solid content contained in the coating (A-6).

### Coating (A-7) Making

3-glycidoxypropyltrimethoxysilane was mixed with pure water and hydrolyzed to make 44.4 g of an aqueous solution of 3-glycidoxypropyltrimethoxysilane hydrolysate. The content of the 3-glycidoxypropyltrimethoxysilane hydrolysate based on the weight of the resulting aqueous solution was 5% by weight. The aqueous solution of the 3-glycidoxypropyltrimethoxysilane hydrolysate and 100 g of the aqueous dispersion of platinum-supported tungsten oxide particles prepared above (platinum-supported tungsten oxide particle content: 20% by weight) were stirred using a magnetic stirrer and a stirrer to give a mixed liquid. To the mixed liquid was added 75.8 g of pure water to give 220.2 g of the coating (A-7) having a solid content concentration of 10% by weight. The content of the binder of the coating (A-7) was 10% by weight based on the weight of the total solid content contained in the coating (A-7).

### Coating (A-8) Making

3-glycidoxypropyltrimethoxysilane was mixed with pure water and hydrolyzed to make 100 g of an aqueous solution of 3-glycidoxypropyltrimethoxysilane hydrolysate. The content of the 3-glycidoxypropyltrimethoxysilane hydrolysate based on the weight of the resulting aqueous solution was 6% by weight. The aqueous solution of the 3-glycidoxypropyltrimethoxysilane hydrolysate and 100 g of the aqueous dispersion of platinum-supported tungsten oxide particles prepared above (platinum-supported tungsten oxide particle content: 20% by weight) were stirred using a magnetic stirrer and a stirrer to give a mixed liquid. To the mixed liquid was added 50.0 g of pure water to give 250.0 g of the coating (A-8) having a solid content concentration of 10% by weight. The content of the binder of the coating (A-8) was 20% by weight based on the weight of the total solid content contained in the coating (A-8).

### Coating (A-9) Making

Titanium oxide and pure water were mixed to make 100 g of an aqueous dispersion of the titanium oxide. The content of the titanium oxide based on the weight of the resulting aqueous dispersion was 20% by weight. 3-glycidoxypropyltrimethoxysilane was mixed with pure water and hydrolyzed to make 10.1 g of an aqueous solution of 3-glycidoxypropyltrimethoxysilane hydrolysate. The content of the 3-glycidoxypropyltrimethoxysilane hydrolysate based on the weight of the resulting aqueous solution was 2% by weight. The aqueous solution of the 3-glycidoxypropyltrimethoxysilane hydrolysate and the aqueous dispersion of titanium oxide were stirred using a magnetic stirrer and a stirrer to give a mixed liquid. To the mixed liquid was added 0.200 g of cuprous oxide and 92.0 g of pure water to give 202.3 g of the coating (A-9) having a solid content concentration of 10% by weight. The content of the binder of the coating (A-9) was 1% by weight based on the weight of the total solid content contained in the coating (A-9). The content of cuprous oxide of the coating (A-9) was 1% by weight based on the weight of the total solid content contained in the coating (A-9).

### Coating (A-10) Making

3-glycidoxypropyltrimethoxysilane was mixed with pure water and hydrolyzed to make 10.1 g of an aqueous solution of 3-glycidoxypropyltrimethoxysilane hydrolysate. The content of the 3-glycidoxypropyltrimethoxysilane hydrolysate based on the weight of the resulting aqueous solution was 2% by weight. The aqueous solution of the 3-glycidoxypropyltrimethoxysilane hydrolysate and 100 g of the aqueous dispersion of platinum-supported tungsten oxide particles prepared above (platinum-supported tungsten oxide particle content: 20% by weight) were stirred using a magnetic stirrer and a stirrer to give a mixed liquid. To the mixed liquid was added 0.200 g of cuprous oxide and 92.0 g of pure water to give 202.3 g of the coating (A-10) having a solid content concentration of 10% by weight. The content of the binder of the coating (A-10) was 1% by weight based on the weight of the total solid content contained in the coating (A-10). The content of cuprous oxide of the coating (A-10) was 1% by weight based on the weight of the total solid content contained in the coating (A-10).

### Coating (A-11) Making

Titanium oxide and pure water were mixed to make 100 g of an aqueous dispersion of the titanium oxide. The content of the titanium oxide based on the weight of the resulting aqueous dispersion was 20% by weight. 3-glycidoxypropyltrimethoxysilane was mixed with pure water and hydrolyzed to make 133.5 g of an aqueous solution of 3-glycidoxypropyltrimethoxysilane hydrolysate. The content of the 3-glycidoxypropyltrimethoxysilane hydrolysate based on the weight of the resulting aqueous solution was 5% by weight. The above two liquids (aqueous dispersion and aqueous solution) were stirred using a magnetic stirrer and a stirrer to give a mixed liquid. To the mixed liquid was added 33.0 g of pure water to give 266.5 g of the coating (A-11) having a solid content concentration of 10% by weight. The content of the binder of the coating (A-11) was 25% by weight based on the weight of the total solid content contained in the coating (A-11).

### Coating (A-12) Making

3-glycidoxypropyltrimethoxysilane was mixed with pure water and hydrolyzed to make 133.5 g of an aqueous solution of 3-glycidoxypropyltrimethoxysilane hydrolysate. The content of the 3-glycidoxypropyltrimethoxysilane hydrolysate based on the weight of the resulting aqueous solution was 5% by weight. The aqueous solution of the 3-glycidoxypropyltrimethoxysilane hydrolysate and 100 g of the aqueous dispersion of platinum-supported tungsten oxide particles prepared above (platinum-supported tungsten oxide particle content: 20% by weight) were stirred using a magnetic stirrer and a stirrer to give a mixed liquid. To the mixed liquid was added 33.0 g of pure water to give 266.5 g of the coating (A-12) having a solid content concentration of 10% by weight. The content of the binder of the coating (A-12) was 25% by weight based on the weight of the total solid content contained in the coating (A-12).

### Coating (B-1) Making

Titanium oxide and pure water were mixed to make 200 g of an aqueous dispersion of the titanium oxide. The content of the titanium oxide based on the weight of the resulting aqueous dispersion was 10% by weight. The resulting aqueous dispersion was used as the coating (B-1). The coating (B-1) did not contain a binder.

### Coating (B-2) Making

To give 200 g of the coating (B-2) having a solid content concentration of 10% by weight were mixed 100 g of the aqueous dispersion of platinum-supported tungsten oxide particles prepared above (platinum-supported tungsten oxide particle content: 20% by weight) and pure water. The coating (B-2) did not contain a binder.

### Coating (B-3) Making

Titanium oxide and pure water were mixed to make 100 g of an aqueous dispersion of the titanium oxide. The content of the titanium oxide based on the weight of the resulting aqueous dispersion was 20% by weight. By stirring at room temperature for 1 hour was hydrolyzed 2.00 g of vinyltrimethoxysilane with 0.70 g of water and 0.035 g of a 1N acetic acid aqueous solution to make 2.7 g of an aqueous dispersion of vinyltrimethoxysilane hydrolysate. The content of the vinyltrimethoxysilane hydrolysate based on the weight of the resulting dispersion was 73% by weight. 0.274 g of the resulting aqueous dispersion was used for a reaction. The above two liquids (aqueous dispersion of titanium oxide and aqueous dispersion of the vinyltrimethoxysilane hydrolysate) were stirred using a magnetic stirrer and a stirrer to give a mixture. To the mixture was added 101.8 g of pure water to give 202.0 g of the coating (B-3) having a solid content concentration of 10% by weight. The content of the binder of the coating (B-3) was 1% by weight based on the weight of the total solid content contained in the coating (B-3).

### Coating (B-4) Making

Titanium oxide and pure water were mixed to make 100 g of an aqueous dispersion of the titanium oxide. The content of the titanium oxide based on the weight of the resulting aqueous dispersion was 20% by weight. By stirring at room temperature for 1 hour was hydrolyzed 2.00 g of vinyltrimethoxysilane with 0.70 g of water and 0.035 g of a 1N acetic acid aqueous solution to make 2.7 g of an aqueous dispersion of vinyltrimethoxysilane hydrolysate. The above two liquids (aqueous dispersion of titanium oxide and aqueous dispersion of the vinyltrimethoxysilane hydrolysate) were stirred using a magnetic stirrer and a stirrer to give a mixture. To the mixture was added 117.3 g of pure water to give 220.0 g of the coating (B-4) having a solid content concentration of 10% by weight concentration. The content of the binder of the coating (B-4) was 10% by weight based on the weight of the total solid content contained in the coating (B-4).

### Evaluation Methods and Evaluation Results of The Coatings

### Making Photocatalytic Body for Evaluation

The coatings (A-1) to (A-12) and (B-1) to (B-4) were used to make photocatalytic bodies for evaluation each including a photocatalytic layer on a substrate. As substrates for making photocatalytic bodies for evaluation, three types of substrates, substrate 1, substrate 2 and substrate 3 described below were used.

Substrate 1: borosilicate glass (length 50 mm×width 50 mm, thickness 1 mm)
Substrate 2: tile (“Mio 50 Neutral White” manufactured by TOTO Ltd.)
Substrate 3: tile (“Ecocarat Fine Base Simple” manufactured by LIXIL Group Corporation)

First, the substrate was treated with ultraviolet light irradiation for 30 minutes using an ultraviolet light ozone irradiation apparatus equipped with a low-pressure mercury lamp (model: UV-312, manufactured by Technovision, Inc.). In this way, a surface of the base material was modified to be hydrophilic. Then, the coating was applied multiple times on the base material using a spin coater (“ACT-220DII” manufactured by Active Co., Ltd.) until the thickness of the coated film (photocatalytic layer) after drying of the coating applied to the substrate becomes 5.0 g/m², and dried at 120° C. for 1 hour. In this way, the photocatalytic body for evaluation including the photocatalytic layer on the substrate was given.

### Water Resistance Test

A water resistance test was carried out by the method described below. In detail, 100 mL of water was poured into a glass container with a volume of 500 mL to immerse the photocatalytic body for evaluation. While the photocatalytic body for evaluation was immersed in water, the photocatalytic body for evaluation was placed at a water temperature of 20° C. for 24 hours. The photocatalytic body for evaluation was removed from water, and the remaining water was then dried at 100° C. for 24 hours to measure the weight of the component stripped off from the photocatalytic body for evaluation (stripped component). A stripped rate (unit: % by weight) was calculated from the weight of the stripped component based on formula “stripped rate=100×weight of stripped component/weight of photocatalytic layer before water resistance test” From the calculated stripped rate, the water resistance of the photocatalytic body for evaluation was evaluated according to the following criteria.

The evaluation criteria of the water resistance are described below. The stripped rate of the photocatalytic body for evaluation using each of the substrates 1 to 3 are shown in Table 2. In addition, in Table 2, “NG” is described for the stripped rate at which the water resistance is evaluated to be failure.

Good: the stripped rate is 0% or more and less than 10%.
Failure (NG): the stripped rate is 10% or more.

### Durability Test

The durability test was carried out by the method described below. The photocatalytic body for evaluation after the water resistance test was dried at 40° C. for 24 hours. After drying, four pieces of mending tape (tape obtained by cutting “model: No. 810-3-12” manufactured by 3M Company into a size of 50 mm in length and 12 mm in width) were stuck in parallel on the surface of the photocatalytic layer of the photocatalytic body for evaluation. Then, the four pieces of mending tape were peeled off from the surface of the photocatalytic layer. The adhesion surfaces of the four pieces of mending tape peeled off were observed visually, and the presence or absence of deposits from the peeled photocatalytic layer was confirmed.

The evaluation criteria of the durability are described below. The evaluation results of the durability of the photocatalytic bodies for evaluation using each of the substrates 1 to 3 are shown in Table 2. Furthermore, the photocatalytic body which is evaluation C or evaluation D was evaluated that the durability is failure (NG). In Table 2, “NG” is described for evaluation C and evaluation D at which the durability is evaluated to be failure.

Evaluation A: No deposit from the peeled photocatalytic layer is observed on any of the four pieces of mending tape.
Evaluation B: Deposits from the peeled photocatalytic layer are observed on one of the four pieces of mending tape.
Evaluation C: Deposits from the peeled photocatalytic layer are observed on two or three of the four pieces of mending tape.
Evaluation D: Deposits from the peeled photocatalytic layer are observed on the four of the four pieces of mending tape.

### Methylene Blue Degradation Test

The methylene blue degradation test (measurement of methylene blue fading rate), which is a test for confirming photocatalytic activity, was carried out by the method described below. 20 μL of methylene blue reagent having a concentration of 100 μmol/L was dropped onto the photocatalytic layer of the photocatalytic body for evaluation using a micro pipette. The photocatalytic body for evaluation after dropping was dried at room temperature. Then, using an ultraviolet lamp, the photocatalytic body for evaluation was continuously irradiated for 24 hours with ultraviolet light having an emission peak of 365 nm and an irradiance of 2.5 mW/cm². Then, the fading rate of methylene blue dropped onto the photocatalytic layer of the photocatalytic body for evaluation was measured. The fading rate of methylene blue was determined by measuring the reflection density of methylene blue on the photocatalytic layer using a black and white reflection densitometer (“R700” manufactured by Ihara Electronic Industries Co., Ltd.) and determining a difference δd in reflectance (unit: %). The fading of methylene blue is caused by a photolysis of methylene blue dropped onto the photocatalytic layer of the photocatalytic body for evaluation. It is shown that the smaller the difference δd in reflectance showing the fading rate of methylene blue is, the better a methylene blue decomposition activity of the photocatalyst layer formed of the coating is.

The evaluation criteria of the methylene blue degradation test are described below. The results of the fading rate of the methylene blue of the photocatalytic body for evaluation using the substrates 3 are shown in Table 2.

Good: the difference δd in reflectance is less than 50%.
Failure (NG): the difference δd in reflectance is 50% or more and 100% or less.

In addition, the evaluation criteria of a comprehensive evaluation of the water resistance test, the durability test and the methylene blue degradation test are described below. In addition, the results of the comprehensive evaluation are shown in Table 2.

Good: there is no failure (NG) evaluation in the water resistance test, the durability test and the methylene blue degradation test.
Failure: there is at least one failure (NG) evaluation in the water resistance test, the durability test and the methylene blue degradation test.

TABLE 2

| | | | | | | | | Decomposition | |
|---|---|---|---|---|---|---|---|---|---|
| | | Water Resistance | | | | | | Activity | |
| | | Substrate 1 | Substrate 2 | Substrate 3 | Durability | | | Substrate 3 | Comprehensive |
| | Coating | [%] | [%] | [%] | Substrate 1 | Substrate 2 | Substrate 3 | [%] | Evaluation |
| Example 1 | A-1 | 8 | 8 | 8 | B | B | B | 0 | Good |
| Example 2 | A-2 | 6 | 6 | 6 | A | A | A | 0 | Good |
| Example 3 | A-3 | 5 | 4 | 4 | A | A | A | 0 | Good |
| Example 4 | A-4 | 4 | 2 | 2 | A | A | A | 0 | Good |
| Example 5 | A-5 | 9 | 9 | 9 | B | B | B | 0 | Good |
| Example 6 | A-6 | 6 | 6 | 6 | A | A | A | 0 | Good |
| Example 7 | A-7 | 5 | 5 | 4 | A | A | A | 0 | Good |
| Example 8 | A-8 | 4 | 3 | 3 | A | A | A | 0 | Good |
| Example 9 | A-9 | 5 | 5 | 5 | A | A | A | 0 | Good |
| Example 10 | A-10 | 5 | 5 | 5 | A | A | A | 0 | Good |
| Example 11 | A-11 | 2 | 2 | 2 | A | A | A | 20 | Good |
| Example 12 | A-12 | 2 | 2 | 2 | A | A | A | 24 | Good |
| Comparative | B-1 | 96 (NG) | 92 (NG) | 92 (NG) | D (NG) | D (NG) | D (NG) | 0 | Failure |
| Example 1 | | | | | | | | | |
| Comparative | B-2 | 95 (NG) | 94 (NG) | 94 (NG) | D (NG) | D (NG) | D (NG) | 0 | Failure |
| Example 2 | | | | | | | | | |
| Comparative | B-3 | 95 (NG) | 94 (NG) | 93 (NG) | D (NG) | D (NG) | D (NG) | 0 | Failure |
| Example 3 | | | | | | | | | |
| Comparative | B-4 | 95 (NG) | 94 (NG) | 93 (NG) | D (NG) | D (NG) | D (NG) | 0 | Failure |
| Example 4 | | | | | | | | | |

As shown in Table 1, the coatings (A-1) to (A-12) contained at least a photocatalytic particle, a binder and water. The binder included a water soluble hydrolysate of a silane coupling agent having an ethylene oxide structure (more particularly, a hydrolysate of 3-glycidoxypropyltrimethoxysilane). Therefore, as shown in Table 2, a photocatalytic layer formed of the coatings (A-1) to (A-12) was excellent in water resistance and durability. In addition, the photocatalytic layer formed of the coatings (A-1) to (A-12) maintained methylene blue decomposition activity more than the desired value.

On the other hand, as shown in Table 1, the coatings (B-1) and (B-2) each did not contain a binder. The coatings (B-3) and (B-4) contained vinyltrimethoxysilane hydrolysate as a binder. However, the vinyltrimethoxysilane hydrolysate was not the water-soluble hydrolysate of the silane coupling agent having the ethylene oxide structure. Therefore, as shown in Table 2, the photocatalytic layer formed of each of the coatings (B-1) to (B-4) was inferior in the water resistance and the durability.

From the above, it was shown that the coating of the present invention, and the coating produced by the production process of the present invention are excellent in water resistance and durability while maintaining photocatalytic activity. In addition, according to the process for producing the photocatalytic body of the present invention, it was shown that the photocatalytic body which is excellent in water resistance and durability while maintaining the photocatalytic activity may be produced.

The coating of the present invention, the coating produced by the production process of the present invention, and the photocatalytic body produced by the production process of the present invention may be utilized for photocatalytic activity products such as building materials, car interior materials, household appliances and textile products.

What is claimed is:

1. A photocatalytic coating containing at least a photocatalytic particle, a binder and water, wherein
the binder includes a water-soluble hydrolysate of a silane coupling agent having an ethylene oxide structure.

2. The photocatalytic coating according to claim 1, wherein a content of the hydrolysate is 0.5% by weight or more and 20% by weight or less, based on a weight of a total solid content contained in the photocatalytic coating.

3. The photocatalytic coating according to claim 1, wherein a content of the photocatalytic particle is 75% by weight or more and 99% by weight or less, based on a weight of a total solid content contained in the photocatalytic coating.

4. The photocatalytic coating according to claim 1, wherein the silane coupling agent having the ethylene oxide structure is a silane coupling agent represented by general formula (1X): 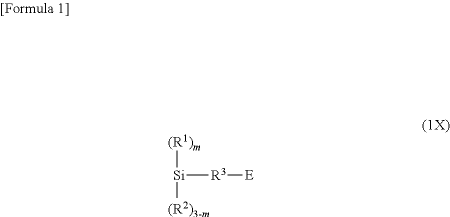
in the general formula (1X), R¹ represents an alkoxy group, R² represents an alkyl group, R³ represents an alkylene group, m represents an integer of 1 to 3, and E represents a group represented by general formula (E1) or (E2): 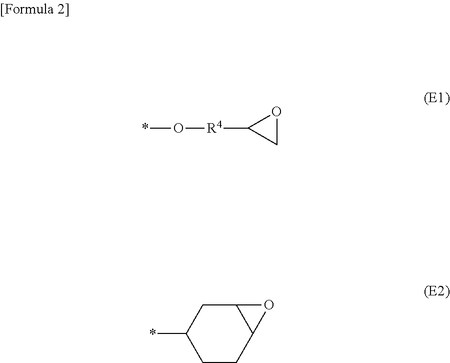
in the general formula (E1), R⁴ represents an alkylene group, * represents a bond bonded to R³, and in the general formula (E2), * represents a bond bonded to R³.

5. The photocatalytic coating according to claim 1, wherein the silane coupling agent having the ethylene oxide structure is 3-glycidoxypropyltrimethoxysilane.

6. The photocatalytic coating according to claim 1, further containing a spacer particle having an average particle diameter larger than an average particle diameter of the photocatalytic particle, wherein
the photocatalytic particle contains metal or metal oxide, and
the spacer particle contains metal or metal oxide different from the metal or metal oxide of the photocatalytic particle.

7. A process for producing the photocatalytic coating according to claim 1, the process comprising mixing the binder including the hydrolysate, the photocatalytic particle, and water to give the photocatalytic coating.

8. The process for producing the photocatalytic coating according to claim 7, further comprising hydrolyzing the silane coupling agent having the ethylene oxide structure to give the hydrolysate.

9. A process for producing a photocatalytic body including a base material and a photocatalytic layer provided on the base material, the process comprising applying the photocatalytic coating according to claim 1 on the base material and heating the photocatalytic coating to bind the photocatalytic particle and the base material via the binder including the hydrolysate.

10. The process for producing the photocatalytic body according to claim 9, wherein the hydrolysate and the photocatalytic particle are dehydrated and condensed by the heating, and the hydrolysate and the base material are dehydrated and condensed, by the heating.

11. The process for producing the photocatalytic body according to claim 9, wherein a surface of the base material is modified to be hydrophilic before the photocatalytic coating is applied to the base material.
